(19) United States
(12) Patent Application Publication
(10) Pub. No.: US 2013/0015318 A1
(43) Pub. Date: Jan. 17, 2013

(54) LAYERED CRUCIBLE FOR CASTING SILICON INGOT AND METHOD OF PRODUCING SAME

(71) Applicants: Saburo Wakita, Noda-shi (JP); Koji Tsuzukihashi, Akita-shi (JP); Hiroshi Ikeda, Tokyo (JP); Masahiro Kanai, Akita-shi (JP)

(72) Inventors: Saburo Wakita, Noda-shi (JP); Koji Tsuzukihashi, Akita-shi (JP); Hiroshi Ikeda, Tokyo (JP); Masahiro Kanai, Akita-shi (JP)

(73) Assignees: Mitsubishi Materials Electronic Chemicals Co., Ltd., Akita-shi (JP); Mitsubishi Materials Corporation, Tokyo (JP)

(21) Appl. No.: 13/637,675

(22) PCT Filed: Mar. 28, 2011
(86) PCT No.: PCT/JP2011/057708

§ 371 Date: Sep. 27, 2012

(30) Foreign Application Priority Data
Mar. 31, 2010 (JP) 2010-080973

(51) Int. Cl. B28B 7/36; B28B 7/38

(52) U.S. Cl. 249/114.1; 427/133

(57) ABSTRACT

Provided are a layered crucible for casting a silicon ingot that can suppress dissolution of oxygen into the silicon ingot and a method of producing the same crucible. The layered crucible for casting a silicon ingot is used in the production of a silicon ingot by melting and casting a silicon raw material. The layered crucible comprising: a silica layer provided on the inner side of a mold; and a barium coating layer provided on the surface of the silica layer.

### CROSS-REFERENCE TO RELATED PATENT APPLICATIONS

This application is a U.S. National Phase Application under 35 U.S.C. §371 of International Patent Application No. PCT/JP2011/057708, filed Mar. 28, 2011, and claims the benefit of Japanese Patent Application No. 2010-080973, filed Mar. 31, 2010, all of which are incorporated by reference herein. The International Application was published in Japanese on Oct. 6, 2011 as International Publication No. WO/2011/122585 under PCT Article 21(2).

### FIELD OF THE INVENTION

The present invention relates to improvement of a layered crucible for casting a silicon ingot and method of producing the same.

### BACKGROUND OF THE INVENTION

Patent Reference 1 discloses a crucible for producing a silicon ingot that is used in manufacture of silicon substrates of cells for photovoltaic power generation with excellent photo-electric conversion efficiency.

As shown in a cross-section of FIG. 2, the crucible for producing a silicon ingot disclosed in Patent Reference 1 has a structure in which inner side of mold 102 composed of quartz glass or graphite is covered by an inner layer 103 that is formed by bonding fine fused silica sand 161 of 50 to 300 μm by silica. In more detail, as shown in partial enlarged view A of FIG. 2, the inner layer 103 includes silica 107 that bonds the fine fused silica sand 161. The inner layer 103 that includes the fine fusion silica sand 161 is easily delaminated form the inner wall of the mold 102. Therefore, delamination occurs if a periphery of a silicon ingot is dragged by the inner wall of the mold during solidification of silicon melt that has been poured into the crucible 106. As a result, inner stress does not remain in the silicon ingot. Therefore, inner stress cracking does not occur during the production of the silicon ingot, resulting in enhanced yield. In addition, photo-conversion efficiency of a solar photovoltaic cell is largely improved where a silicon substrate that is produced using the silicon ingot having small residual inner stress is equipped in the cell.

### PRIOR ART REFERENCE

### Patent Reference

Patent Reference 1: Japanese Unexamined Patent Application, First Publication No. H11-244988.

### Problems to be Solved by the Invention

However, there has been a problem in the time of producing a silicon ingot using the above-described conventional crucible 101 for producing a silicon ingot. In this conventional crucible 101 for producing a silicon ingot, the inner layer 103 mainly composed of the silica 107 and the fused silica sand 161 is formed inside the mold 102 composed of quartz glass or graphite. The silica and the fused silica sand as the main constituents of the inner layer react with silicon melt when the crucible is used in production of a silicon ingot, easily resulting in dissolution of oxygen in the silicon ingot. It is difficult to further improve the performance of a solar photovoltaic cell where the silicon substrate of the cell is produced using the silicon ingot dissolving the oxygen.

Based on the consideration of the above-described circumstance, an object of the present invention is to provide a layered crucible for casting a silicon ingot that is capable of suppressing dissolution of oxygen into the silicon ingot, and a method of producing the same crucible.

### SUMMARY OF THE INVENTION

### Solution of the Problems

As a result of extensive investigation to achieve the above-described object, the inventors found that a stucco layer could be crystallized at relatively low temperature where barium (Ba) was included in colloidal silica used as a binder during the formation of the stucco layer. In addition, it was found that the above-described crystallization effect could be achieved by coating barium only on the surface of the silica layer since the barium diffused into the silica layer. Thus, the present invention was accomplished.

A first aspect of the present invention is a layered crucible (stacked crucible) for casting a silicon ingot by melting silicon raw material and casting a melt, including: a silica layer that is provided to inner side of a mold; and a barium coating layer that is provided to a surface of the silica layer.

The barium coating layer may include barium hydroxide or barium carbonate having an average particle diameter of 0.1 to 0.01 μm.

The barium coating layer may has an average thickness of 0.01 to 1.0 μm.

Barium concentration in the silica layer may be higher in the vicinity of interface with the barium coating layer than in the vicinity of interface with the mold.

The above-described silica layer may has a layered structure including: an outer silica layer that is provided to the inner side of the mold and that includes at least one outer stucco layer in which coarse fused silica sand having an average particle diameter of 500 to 1500 μm is bonded by silica; and an inner silica layer that is provided to the inner side of the outer silica layer and that includes at least one inner stucco layer in which fine fused silica sand having an average particle diameter of 50 to 300 μm is bonded by silica, wherein the above-described barium coating layer is provided to the inner side of the inner silica layer.

A second aspect of the present invention is a method of producing a layered crucible for casting a silicon ingot, including: performing formation of an outer stucco layer by forming a slurry layer by painting or spraying a slurry including fused silica powder and colloidal silica to an inner side of a mold, and dispersing coarse fused silica sand having an average particle diameter of 500 to 1500 μm to the surface of the slurry layer; performing formation of an inner stucco layer by forming a slurry layer by painting or spraying the slurry onto the outer stucco layer, and dispersing fine fused silica sand having an average particle diameter of 50 to 300 μm to the surface of the slurry layer; performing formation of a barium slurry layer on the top surface by painting or spraying barium slurry including barium hydroxide powder or barium carbonate powder having an average particle diameter of 0.1 to 0.01 μm onto the inner stucco layer; and performing drying and firing to form a silica layer including the outer stucco layer and the inner stucco layer in the inner side of the mold and to form a barium coating layer on the surface of the silica layer.

The above-described formation of the silica layer may include repeating the above-described formation of the inner stucco layer for one or a plurality of times and repeating the above-described formation of the outer stucco layer for one or a plurality of times.

### Effect of the Invention

The layered crucible for casting a silicon ingot according to the present invention includes a silica layer provided to the inner side of a mold, and a barium coating layer provided to the surface of the silica layer. Because of this constitution, crystallization of the silica layer can be enhanced by diffusion of barium in the barium coating layer into the silica layer. As a result, it is possible to suppress dissolution of silica into the silicon raw material during casting a silicon ingot from the silicon raw material molten in the crucible for casting a silicon ingot, thereby reducing oxygen concentration in the silicon ingot. Therefore, where a silicon ingot produced by the layered crucible for producing a silicon ingot according to the present invention is used in a solar battery cell, it is possible to improve photo-electric conversion efficiency of the cell.

The method of producing a layered crucible for casting s silicon ingot according to the present invention includes forming an outer stucco layer in the inner side of the mold, forming an inner stucco layer onto the inner stucco layer, and forming a barium slurry layer on the top surface by painting or spraying barium slurry on the inner stucco layer, and forming a barium coating layer on the surface of the silica layer by drying and firing the layered structure.

The crucible for casting a silicon ingot according to the present invention can be produced by the above-described simple method.

### BRIEF DESCRIPTION OF THE DRAWINGS

FIG. 1 is a schematic cross sectional view that shows a layered crucible for producing a silicon ingot according to an embodiment of the present invention.

FIG. 2 is a schematic cross sectional view that shows a layered crucible for producing a silicon ingot according to a prior art.

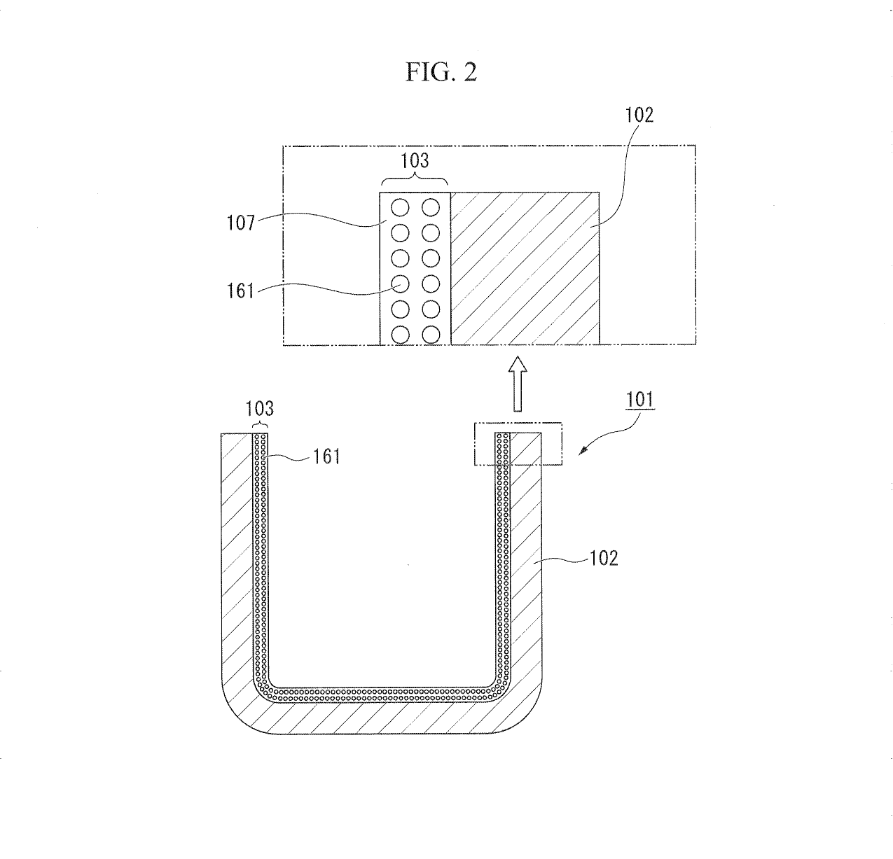

### DETAILED DESCRIPTION OF THE INVENTION

### Mode for Carrying Out the Invention

In the following, a crucible for producing a silicon ingot according to an embodiment of the invention is explained in detail. In the drawings used in the below described explanation, some characteristic parts are shown in enlarged view for the convenience of understanding. Therefore, proportion of dimension in respective parts is not always similar to the practical proportion.

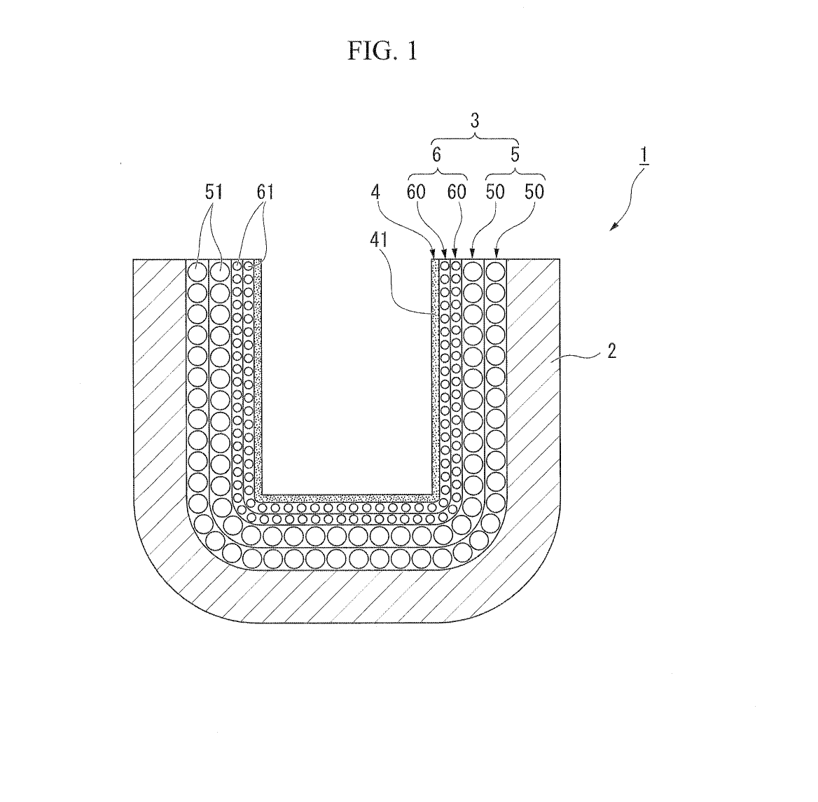

The layered crucible for producing a silicon ingot (hereafter, simply referred to as crucible) 1 of the present embodiment is used in producing a silicon ingot by melting a silicon raw material and casting a melt. As shown in FIG. 1, a schematic constitution of the crucible 1 includes a silica layer 3 disposed to inner side of a mold 2, and a barium coating layer 4 disposed on a surface of the silica layer 3.

The mold 2 is constituted of quartz glass or graphite. A space of arbitrary dimension and shape (for example, columnar space, hexagonal prism space, cubic space, rectangular space) is formed in the inner side of the crucible. The shape and dimension of the space are not limited to particular constitution.

For example, where a crucible 1 constituted of a mold 2 having the inside space of cubic or rectangular parallel piped shape is used in production of a silicon ingot, a silicon ingot having square or rectangular cross section can be obtained. Where the silicon ingot having square or rectangular cross section is used in production of silicon substrate having square or rectangular shape, for example, silicon substrate of solar photovoltaic cell, it is possible to utilize the expensive silicon ingot most efficiently.

As shown in FIG. 1, the silica layer 3 is disposed to inner side (interior side) of the mold 2, and has a layered structure that is constituted of an outer silica layer 5 that includes at least one outer stucco layer 50, and an inner silica layer 6 that includes at least one inner stucco layer 60.

When the silicon ingot is produced by pouring silicon melt to the cavity of the crucible 1 and solidifying the silicon melt, outer periphery of the silicon ingot is dragged by the inner wall of the crucible 1. In this time, since the silica layer 3 has the above-described layered structure, inner silica layer 6 is adhered to the silicon ingot and is delaminated (exfoliated) from the outer silica layer 5. Therefore, inner stress is not generated in the solidified silicon ingot. Thus, it is possible to suppress occurrence of cracks and dislocations which have been evident in a silicon ingot achieved by the conventional quartz crucible.

The outer silica layer 5 is constituted to include one or more outer stucco layer 50 in which coarse fused silica sand 51 having an average particle diameter of 500 to 1500 μm is bonded by silica.

Here, the average particle diameter of the coarse fused silica sand 51 was limited to 500 to 1500 μm based on the following reason. Coarse silica sand 51 having an average particle diameter larger than 1500 μm is not preferred since density of the crucible 1 is reduced resulting in reduction of strength.

On the other hand, when the average diameter of the coarse fused silica sand 51 is smaller than 500 μm, it is not preferred since the strength of the outer silica layer 5 is reduced and capability of delamination of the inner silica layer 6 is deteriorated.

The outer silica layer 5 is required to have a thickness of at least about 3 mm so as to maintain the strength of the crucible 1 during the production of the silicon ingot. On the other hand, too thick thickness of the outer silica layer 5 is not preferred because of expensive cost. Therefore, it is preferable that a practical thickness of the outer silica layer 5 is in the range of 3 to 20 mm.

The inner silica layer 6 is constituted to include one or more inner stucco layer 60 in which fine fused silica sand 61 having an average particle diameter of 50 to 300 μm is bonded by silica.

Here, the average particle diameter of the fine fused silica sand 61 was limited to 50 to 300 μm based on the following reason. Fine silica sand 61 having an average particle diameter larger than 300 μm is not preferred since the capability of delamination from the outer silica layer 5 is disturbed. On the other hand, where the average diameter 61 of the fine fused silica sand 61 is smaller than 50 μm, it is not preferred since the inner silica layer 6 is delaminated too easily such that inner silica layer 6 is delaminated during the production of the crucible 1.

Thickness of the inner silica layer 6 is not particularly limited provided that the delamination from the outer silica layer 5 due to solidification shrinkage of the silicon ingot is allowed to occur during production of the silicon ingot using the crucible 1. Preferably, the above-described thickness is practically in the range of 0.1 to 5 mm.

The silica that bonds the coarse fused silica sand 51 or the fine fused silica sand in the outer silica layer 5 and the inner silica layer 6 contains sodium of 10 to 6000 ppm.

Here, concentration of sodium in the silica that constitutes a matrix of the outer silica layer 5 and the inner silica layer is preferably in the range of 10 to 6000 ppm because of the following reason. Where the sodium concentration is smaller than 10 ppm, it is not preferred since the silica is not sufficiently adhered to the coarse fused silica sand 51 or the fine fused silica sand 61.

On the other hand, where the sodium concentration of the silica exceeds 6000 ppm, it is not preferred since more than the allowable amount of sodium is contained in the silicon ingot as impurities. A more preferable range of sodium concentration in the silica is 500 to 6000 ppm.

As shown in FIG. 1, the barium coating layer 4 is formed on the surface of the silica layer 3 so as to make the barium to diffuse into the silica layer 3 thereby enhancing the crystallization of the silica layer 3.

The barium coating layer 4 is constituted of barium hydroxide or barium carbonate (hereafter, referred to as barium-containing compound) 41 having an average particle diameter of 0.1 to 0.01 μm.

Here, the average particle diameter of the barium-containing compound 41 was limited to 0.1 to 0.01 μm because of the following reason.

Where the average particle diameter of the barium-containing compound 41 is smaller than 0.01 μm, it is not preferred since agglomeration easily occurs. On the other hand, where the average particle diameter of the barium-containing compound 41 exceeds 0.1 μm, it is not preferred because of difficulty in uniform dispersion.

A thickness of the barium coating layer 4 is not particularly limited provided that the layer can be coated without delamination. Preferably, the thickness of the layer is in the range of 0.01 to 0.05 μm in average thickness.

The barium coating layer 4 exists as a single distinct layer and can be distinguished from the silica layer 3 by visual observation.

In the crucible 1 of the present embodiment, barium concentration in the silica layer 3 is higher in the vicinity of the interface with the barium coating layer 4 than in the vicinity of interface with the mold 2.

More specifically, where the outer silica layer 5 and the inner silica layer 6 as constituents of the silica layer 3 are compared, barium concentration of the inner silica layer 6 is higher than the barium concentration of the outer silica layer 5.

Where the outer silica layer 5 or the inner silica layer 6 is constituted of two or more outer stucco layers 50 or two or more inner stucco layers 60, barium concentration is higher in a layer provided to the barium coating layer 4-side than in a layer provided to the mold 2-side.

In addition, gradient of barium concentration exists in each of the outer stucco layers 50 and the inner stucco layers 60 such that the barium concentration is higher in the side of the interface with the barium coating layer 4 than in the side of the interface with the mold 2.

Next, a method of producing a crucible 1 of the present embodiment is explained.

Elements of a method of producing a crucible 1 according to the present embodiment 1 includes a step of forming an outer silica layer 5 in the inner side of the mold 2, a step of forming an inner silica layer 6 on the outer silica layer 5, a step of forming a barium slurry layer on the inner silica layer 6, and a step of drying and firing the layered structure. Each step is explained hereinafter.

### Preparation of Slurry

Firstly, a slurry is prepared by mixing 100 to 300 parts of fused silica powder having an average particle diameter of 40 to 100 μm with 100 parts of colloidal silica that includes ultra-fine fused silica powder containing 10 to 6000 ppm of sodium and having an average particle diameter of 1 to 10 nm.

### Formation Step of Outer Silica Layer

In the formation of the outer silica layer 5, firstly, the slurry including fused silica powder and colloidal silica is painted or sprayed to the inner side (inner wall) of the mold 2 to form a slurry layer. Next, an outer stucco layer 50 is formed by dispersing coarse fused silica sand 51 having an average particle diameter of 500 to 1500 μm to the surface of the slurry layer. Outer silica layer 5 is formed by performing one time or repeating a plurality of times the above-described formation of the outer stucco layer 50.

### Formation Step of Inner Silica Layer

In the formation of the inner silica layer, firstly 6, a slurry layer is formed by painting or spraying the above-described slurry onto the outer silica layer 5 (outer stucco layer 50), Next, an inner stucco layer 60 is formed by dispersing fine fused silica sand 61 having an average particle diameter of 50 to 300 μm to the surface of the slurry layer. Inner silica layer 6 is formed by performing one time or repeating a plurality of times the above-described formation of the inner stucco layer 60.

### Formation Step of Barium Slurry Layer

In the formation of the barium slurry layer, firstly, a barium slurry is prepared by mixing barium hydroxide or barium carbonate having an average particle diameter of 0.1 to 0.01 μm with pure water. Next, barium slurry layer is formed by coating or spraying the prepared barium slurry onto the inner silica layer 6 (inner stucco layer 60),

### Drying and Firing

In the drying and firing step, firstly, the mold 2 that is layered with the outer silica layer 5, the inner silica layer 6, and the barium slurry layer on inner side thereof is dried for 24 hours under the environment at a temperature of 20° C. and in a humidity of 50%. Next, the mold 2 is fired in the air atmosphere for 2 hours at 1000° C. By this treatment, a silica layer 3 including the outer silica layer 5 (outer stucco layer 50) and the inner silica layer (inner stucco layer 60) is formed in the inner side of the crucible 2. At the same time, a barium coating layer 4 is formed on the surface of the silica layer 3.

Next, a method of producing a silicon ingot using a crucible 1 of the present embodiment is explained.

Firstly, raw material silicon is filled in the cavity of the crucible 1 and is molten at a temperature of 1500° C. Alternatively, silicon melt of 1500° C. may be poured into the cavity.

Next, by cooling the lower part, the melt is solidified in one direction from the lower part to upper part, thereby producing a silicon ingot.

According to the crucible 1 of the present embodiment, the silica layer 3 has a layered structure including the outer silica layer 5 and the inner silica layer 6. Therefore, when the periphery of the silicon ingot 1 is dragged by the inner wall of the crucible 1, inner silica layer 6 is adhered to the silicon ingot and is delaminated from the outer silica layer 5. By this effect, inner stress is not generated in the solidified silicon ingot. As a result, it is possible to produce a silicon ingot while suppressing occurrence of cracks and dislocations which have been evident in silicon ingots produced using the conventional quarts crucible.

In the conventional crucible, degree of crystallization of the silica layer formed inside the mold has been restricted to about 60% even when a silicon ingot is produced in casting conditions at 1500° C., and sufficient crystallization has not been achieved. Therefore, there has been a problem of dissolution of oxygen into the silicon melt due to reaction of the molten silicon with the silica and fused silica sand as the main components of the silica layer. Practically, oxygen concentration of the produced silicon ingot was about 20 ppm.

According to the crucible 1 of the present embodiment, barium coating layer 4 is formed on the surface of the silica layer 3 disposed inside the mold 2, and barium diffuses into the silica layer 3 from the barium coating layer 4. As a result, crystallization of the silica layer 3 is enhanced.

That is, sufficient crystallization is achieved such that degree of crystallization of the silica layer 3 provided to inside the mold 2 is about 90%, when a silicon ingot is produced under casting conditions at 1500° C. As a result, reaction of the molten silicon with the silica and fused silica sand as the main components of the silica layer can be suppressed. Practically, oxygen concentration of a silicon ingot that is produced using the crucible 1 of the present embodiment is reduced to about 10 ppm.

The degree of crystallization of the silica layer can be measured, for example, using an X-ray diffraction apparatus (XRD). Oxygen concentration in the silicon ingot is, for example, measured by FT-IR method.

As explained above, according to a constitution of the present embodiment, the crucible 1 has a silica layer 3 provided inside the mold 2, and a barium coating layer 4 provided on the surface of the silica layer 3. Therefore, barium in the barium coating layer 4 diffuses into the silica layer 3 and enhances the crystallization of the silica layer. 3.

By this effect, it is possible to suppress dissolution of silica into the silicon raw material when a silicon ingot is cast from the silicon raw material molten using the crucible 1, thereby suppressing oxygen concentration in the silicon ingot. Therefore, in a solar battery cell utilizing a silicon ingot produced using the crucible 1 of the present embodiment, it is possible to improve the photo-electric conversion efficiency.

According to a method of producing a crucible 1 of the present embodiment, an outer silica layer 5 (outer stucco layer 50) is formed inside the mold 2, an inner silica layer 6 (inner stucco layer 60) is formed on the outer silica layer 5, a barium slurry layer is formed on the top surface by painting or spraying barium slurry on the inner silica layer 6, and a barium coating layer 4 on the surface of the silica layer 3 is formed by drying and firing the stacked layers. By such simple process, it is possible to produce the above-described crucible 1.

### EXAMPLE

In the following, effect of the invention is explained based on the example. It should be noted that the present invention is not limited by the example.

### Example 1

A quarts glass mold having a dimension defined by an inner diameter of 170 mm, an outer diameter of 190 mm, and a depth of 150 mm was prepared.

A slurry was prepared by mixing 200 parts of fused silica powder having an average particle diameter of 40 μm to 100 parts of colloidal silica that included 30% by volume of ultrafine fused silica powder containing 0.5% of sodium and having an average particle diameter of 10 nm or less.

A barium slurry containing 10% by volume of barium hydroxide having an average particle diameter of 0.1 μm or less and the balance of water was prepared.

A slurry layer was formed by painting the above-described slurry on the inner side of the quartz glass mold, and an outer stucco layer was formed by dispersing coarse fused silica sand having an average particle diameter of 800 μm on the surface of the slurry layer. An outer silica layer was formed by repeating the above-described steps (painting and dispersing) three times.

Next, a slurry layer was formed by painting the above-described slurry on the inner side of the outer silica layer, and an inner stucco layer was formed by dispersing fine fused silica sand having an average particle diameter of 100 μm on the surface of the slurry layer. An inner silica layer was formed by repeating the above-described steps (painting and dispersing) three times.

Next, a barium slurry layer was formed by paining the above-described barium slurry on the inner side of the inner silica layer. Then, by performing drying and firing by maintaining the mold in the air atmosphere at a temperature of 1000° C. for 2 hours, a silica layer of 3 mm in total thickness and a barium coating layer of 0.05 μm in thickness were formed inside the quartz glass mold. Thus, a layered crucible for producing a silicon ingot (hereafter, referred to as a crucible) of Example 1 was produced.

Scraps (for example, bottom, tail or the like) wasted in the single crystal pulling process were installed as a raw material in the crucible of Example 1, and the raw material was molten by maintaining the temperature at 1500° C. The obtained silicon melt was cooled from the bottom direction of the mold at a cooling rate of 0.3° C./min, and a silicon ingot with a single solidification direction was produced.

Under the visual observation to examine occurrence of inner stress cracking in the obtained silicon ingot with a single solidification direction, inner stress cracking was not detected.

In the measurement, interstitial oxygen concentration included in the obtained silicon ingot with a single solidification direction was 1.0×10⁻¹⁸ (atoms/cc).

A silicon substrate for photovoltaic power generation was produced by slicing the obtained silicon ingot with a single solidification direction, and photo-electric conversion efficiency of the substrate was examined. As a result, the substrate showed a photo-electric conversion efficiency of about 15%.

### Comparative Example 1

In the similar manner as Example 1, an outer stucco layer was formed by forming a slurry layer by painting the above-described slurry in the inside of the above-described quartz glass crucible, and dispersing coarse fused silica sand having an average particle diameter of 250 μm on the surface of the slurry layer. An outer silica layer was formed by repeating the above-described steps three times.

Next, an inner stucco layer was formed by forming a slurry layer by painting the above-described slurry in the inside of the outer silica layer, and dispersing fine fused silica sand having an average particle diameter of 20 μM on the surface of the slurry layer. An inner silica layer was formed by repeating the above-described steps three times.

Next, by holding the mold at a temperature of 1000° C. for 2 hours in the air atmosphere, a silica layer of 3 mm in total thickness was formed in the inside of the quartz glass mold. Thus, a crucible of Comparative Example 1 was produced.

In the same manner as Example 1, scraps wasted in the single crystal pulling process were installed as a raw material in the crucible of Comparative Example 1, and the raw material was molten by maintaining the temperature at 1500° C. The obtained silicon melt was cooled at a cooling rate of 0.3° C./min, and a silicon ingot with a single solidification direction was produced.

Under the visual observation of the surface of the obtained silicon ingot with a single solidification direction to examine occurrence of inner stress cracking in the ingot, inner stress cracking was not detected.

In the measurement, interstitial oxygen concentration included in the obtained silicon ingot with a single solidification direction was 2.0×10⁻¹⁸ (atoms/cc).

A silicon substrate for photovoltaic power generation was produced by slicing the obtained silicon ingot solidified in a single direction, and photo-electric conversion efficiency of the substrate was examined. As a result, the substrate showed photo-electric conversion efficiency of about 14%.

### INDUSTRIAL APPLICABILITY

In solar battery cell utilizing a silicon ingot produced by a layered crucible for casting a silicon ingot according to the present invention, it is possible to enhance photo-electric conversion efficiency.

### EXPLANATION OF SYMBOLS

1 Layered crucible for casting a silicon ingot
2 Mold
3 Silica layer
4 Barium coating layer
5 Outer silica layer
6 Inner silica layer
41 Barium containing compound
51 Coarse fused silica sand
61 Fine fused silica sand

1. A layered crucible for casting a silicon ingot used in a production of a silicon ingot by melting and casting a silicon raw material, the crucible comprising:
a silica layer provided on an inner side of a mold; and
a barium coating layer provided on a surface of the silica layer.

2. The layered crucible for casting a silicon ingot according to claim 1, wherein the barium coating layer includes barium hydroxide or barium carbonate having an average particle diameter of 0.1 to 0.01 μm.

3. The layered crucible for casting a silicon ingot according to claim 1, wherein an average thickness of the barium coating layer is 0.01 to 1.0 μm.

4. The layered crucible for casting a silicon ingot according to claim 1, wherein a barium concentration in the silica layer is higher in the vicinity of the interface with the barium coating layer than in the vicinity of the interface with the mold.

5. The layered crucible for casting a silicon ingot according to claim 1,
wherein the silica layer has a layered structure including:
an outer silica layer that is provided on the inner side of the mold and that includes at least one outer stucco layer in which coarse fused silica sand having an average particle diameter of 500 to 1500 μm is bonded by silica; and
an inner silica layer that is provided on an inner side of the outer silica layer and that includes at least one inner stucco layer in which fine fused silica sand having an average particle diameter of 50 to 300 μm is bonded by silica, and
wherein a barium coating layer is provided on an inner side of the inner silica layer.

6. A method of producing a layered crucible for casting a silicon ingot, comprising the steps of:
forming an outer stucco layer by forming a slurry layer by painting or spraying a slurry including fused silica powder and colloidal silica on an inner side of a mold, and dispersing coarse fused silica sand having an average particle diameter of 500 to 1500 μm on a surface of the slurry layer;
forming an inner stucco layer by forming a slurry layer by painting or spraying the slurry onto the outer stucco layer, and dispersing fine fused silica sand having an average particle diameter of 50 to 300 μm on a surface of the slurry layer;
forming a barium slurry layer on a top surface by painting or spraying a barium slurry including barium hydroxide powder or barium carbonate powder having an average particle diameter of 0.1 to 0.01 μm onto the inner stucco layer; and
drying and firing to form a silica layer comprising the inner stucco layer and the outer stucco layer on the inner side of the mold and to form a baring coating layer on a surface of the silica layer.

7. The method of producing a layered crucible for casting a silicon ingot according to claim 6, wherein the formation of the silica layer is performed by repeating the formation of the inner stucco layer for one or a plurality of times and repeating the formation of the outer stucco layer for one or a plurality of times.

8. The layered crucible for casting a silicon ingot according to claim 2, wherein an average thickness of the barium coating layer is 0.01 to 1.0 μm.

9. The layered crucible for casting a silicon ingot according to claim 2, wherein a barium concentration in the silica layer is higher in the vicinity of the interface with the barium coating layer than in the vicinity of the interface with the mold.

10. The layered crucible for casting a silicon ingot according to claim 3, wherein a barium concentration in the silica layer is higher in the vicinity of the interface with the barium coating layer than in the vicinity of the interface with the mold.

11. The layered crucible for casting a silicon ingot according to claim 2,
wherein the silica layer has a layered structure including:
an outer silica layer that is provided on the inner side of the mold and that includes at least one outer stucco layer in which coarse fused silica sand having an average particle diameter of 500 to 1500 μm is bonded by silica; and
an inner silica layer that is provided on an inner side of the outer silica layer and that includes at least one inner stucco layer in which fine fused silica sand having an average particle diameter of 50 to 300 μm is bonded by silica, and
wherein a barium coating layer is provided on an inner side of the inner silica layer.

12. The layered crucible for casting a silicon ingot according to claim 3,
wherein the silica layer has a layered structure including:
an outer silica layer that is provided on the inner side of the mold and that includes at least one outer stucco layer in which coarse fused silica sand having an average particle diameter of 500 to 1500 μm is bonded by silica; and
an inner silica layer that is provided on an inner side of the outer silica layer and that includes at least one inner stucco layer in which fine fused silica sand having an average particle diameter of 50 to 300 μm is bonded by silica, and
wherein a barium coating layer is provided on an inner side of the inner silica layer.

13. The layered crucible for casting a silicon ingot according to claim 4,
wherein the silica layer has a layered structure including:
an outer silica layer that is provided on the inner side of the mold and that includes at least one outer stucco layer in which coarse fused silica sand having an average particle diameter of 500 to 1500 μm is bonded by silica; and
an inner silica layer that is provided on an inner side of the outer silica layer and that includes at least one inner stucco layer in which fine fused silica sand having an average particle diameter of 50 to 300 μm is bonded by silica, and
wherein a barium coating layer is provided on an inner side of the inner silica layer.
